(19) United States
(12) Patent Application Publication
(10) Pub. No.: US 2010/0160202 A1
(43) Pub. Date: Jun. 24, 2010

(54) Detergent Composition

(76) Inventors: Chris Efstathios Housmekerides, Ludwigshafen (GR); Roger Kaiser, Ludwigshafen (DE); Jorg Pflug, Ludwigshafen (DE)

Correspondence Address: PARFOMAK, ANDREW N.;NORRIS MCLAUGHLIN & MARCUS PA, 875 THIRD AVE, 8TH FLOOR, NEW YORK, NY, 10022, US

(21) Appl. No.: 12/303,642

(22) PCT Filed: Jun. 7, 2007
(86) PCT No.: PCT/GB07/02091

§ 371 Date: Dec. 5, 2008

(30) Foreign Application Priority Data
Jun. 7, 2006 (GB) 0611206.4

(51) Int. Cl. C11D 3/386

(52) U.S. Cl. 510/218; 510/404; 510/403; 510/405; 510/392

(57) ABSTRACT

A detergent composition comprising; a) a non-phosphorous based builder which is an amino acid based compound or a succinate based compound, b) one or more enzymes which are destabilised by the non-phosphorous containing builder and c) a stabilisation system for the one or more enzymes. The stabilising system comprising one or more divalent metal ion salts and a non-ionic surfactant. Preferably the builder is the tetrasodium salt of glutamic-N,N-diacetic acid and the enzyme comprises protease. The preferred divalent metal ion salts are calcium salts.

### TECHNICAL FIELD

The present invention relates to detergent compositions comprising phosphate-free builders and enzymes. In particular the present invention relates to detergent compositions comprising phosphate-free builders, enzymes and a stabilising system for the enzymes. The detergent compositions may find application especially in dishwashing or laundry applications.

### BACKGROUND OF THE INVENTION

In recent years there has been an increasing trend towards safer and environmentally friendly detergent compositions. This has led to the development of alternative complexing agents (builders) which are used instead of predominantly phosphorous based builders as the latter, e.g. phosphate builders, are often connected with eutrophication issues. Accordingly, low-phosphate and especially phosphate-free detergent compositions are becoming increasingly desirable. The terms ‘phosphate’ and ‘phosphorous-containing’ or ‘phosphorous based’ are used interchangeably herein.

However, phosphates can bind calcium and magnesium ions present in other ingredients in detergent compositions. As they can act as an alkalinity source together with other chemicals such as disilicate, metasilicates and soda they are used to buffer the wash liquor in a washing operation, e.g. in a dishwasher, to above pH 9.

Phosphates are also able to disperse existing calcium carbonate in the wash liquor to prevent spotting on glasses.

Thus, replacing phosphates in a detergent requires that at least four different functions in an alkaline detergent are compensated for; (1) providing alkalinity; (2) buffering capacity, (3)complexing of magnesium and calcium ions; and (4) dispersing capacity of calcium carbonate.

The use of more environmentally friendly biodegradable complexing agents, such as β-alaninediacetic acid (β-ADA) and isoserinediacetic acid (ISDA) in detergents is disclosed in DE-A-3,829,847 and DE-A-4,036,995.

However, these compounds have low complexing action and are thus only a poor replacement for the conventional builders in the finished composition.

One other environmentally friendly builder that has been used in dishwasher detergent formulations are salts of citric acid. This has the advantage that these salts are biodegradable and environmentally friendly. However, the builder performance of citric acid salts is far inferior to that of phosphorus based builders. Additionally this poor performance is even further compromised with increasing temperature: salts of citric acid display especially poor activity above 45° C.

Indeed many of the dishwasher detergents proposed to date which use environmentally friendly complexing agents have the disadvantage that they are only effective at a relatively high pH. In order to provide this high pH, pH adjusting agents usually need to be added to the composition. These pH adjusting agents can act as an additional buffering system, but cause side problems of filming and spotting on dishes. Repeated wash cycles can also lead to glass and machine corrosion, and lime-scale build-up, even on dishes.

Recently, it has been proposed to use amino-acid based or a succinate based compounds as builders in detergent compositions as replacements for phosphate based builders.

For example U.S. Pat. No. 6,426,229 discloses amino-carboxylic acid chelating agents which may be used in detergent compositions. The disclosed builders include the tetra sodium salt of glutamic acid-N,N-diacetic acid. WO 2006/003434 discloses the use of particles of a similar builder, methyl-glycine-diacetic acid, in detergent compositions.

However, a disadvantage which exists with such amino-acid based or succinate based compounds as builders in detergent compositions is that they may destabilise other ingredients in the detergent formulation. In particular the use of such builders typically has a detrimental effect upon the stability and thus performance of enzymes, especially protease enzymes, in detergent compositions. This can lead to a loss of performance of the detergent compositions.

The problem of destabilisation of amylolytic enzyme-containing compositions is known from GB1277479 where water-soluble calcium salts were suggested to act as stabilisers.

GB-A-2373254 discloses enzyme containing liquid detergent compositions comprising an enzyme stabilising metal ion system comprising of calcium ions and magnesium ions present in a weight ratio of 1:1 to 4:1 and a water-soluble polymeric material capable of being cross-linked by borate ions.

U.S. Pat. No. 6,162,259 discloses detergent compositions comprising an amino tricarboxylic acid (which may be MGDA) and which may optionally comprise an enzyme stabilisation system which in turn may comprise a calcium ion.

It is an object of the present invention to address one or more of the above mentioned problems and in particular to provide stable detergent compositions.

In particular, it is an object of the present invention to obviate/mitigate the issues outlined above and/or to offer detergent compositions with usage and/or environmental benefits. In particular it is an object of the present invention to provide detergent compositions comprising a non-phosphate builder and an enzyme which composition provides acceptable stability of the enzyme and/or acceptable performance thereof.

### STATEMENT OF INVENTION

According to the present invention there is provided a detergent composition comprising;
a) a non-phosphorous containing builder which is an amino acid based compound or a succinate based compound,
b) one or more enzymes which are destabilised by the non-phosphorous containing builder, and
c) a stabilisation system for the one or more enzymes wherein the stabilisation system comprises one or more divalent metal compounds or salts and one or more non-ionic surfactants.

Surprisingly, it has been found that compositions according to the invention exhibit good stability of the enzymes contained therein and furthermore have good performance characteristics such as cleaning and/or rinse properties. In particular detergent compositions according to the invention have been found to exhibit good cleaning performance and good enzyme stability. For dishwashing detergents this means that the compositions effectively remove food residues from the items cleaned with the compositions. Most surprisingly the compositions of the invention have been found to be effective at removing or lessening bleachable stains even when the compositions contain little or no bleach.

Furthermore, the detergent compositions of the invention exhibit good rinse performance and have not been found to unacceptably damage the items to be cleaned. This may be achieved through the ability of the compositions to prevent, or even to remove, the build-up of precipitates formed by Ca- and Mg-ions; such as limescale.

Unless stated otherwise, all amounts herein are given as the percentage by weight of active ingredient based upon the weight of the total composition.

### DETAILED DESCRIPTION

The present invention will now be described in further detail. The detergent compositions according to the invention may be formulated as any type of detergents, for example dishwashing detergents, laundry detergents or hard surface cleaners with dishwashing detergents being the most preferred type.

### a) Detergent Composition Format

The detergent composition of the present invention may be of any suitable physical format.

Suitable forms of the detergent compositions including pastes, liquids, solids or gels. Preferably the composition is in the form of a unit dose product, that is a form which is designed to be used as a single portion of detergent composition in a washing operation. Of course, one or more of such single portions may be used in a cleaning operation.

Solid forms include, for example, compositions in the form of a tablet, rod, ball or lozenge. The composition may be a particulate form, loose or pressed to shape or may be formed by injection moulding, by casting or by extrusion. The composition may be encased in a water soluble wrapping, e.g. PVOH or a cellulosic material. The solid product may be provided as a portioned product as desired.

The composition may be in paste, gel or liquid form and these are preferred according to the invention. In particular unit dose (portioned products) of paste, gel or liquid detergent compositions are preferred according to the present invention. An especially preferred product format according to the present invention is a paste, gel or liquid product at least partially surrounded by a water-soluble package, such as a polyvinyl alcohol package. This package may for instance take the form of a capsule, a pouch etc. Preferably the composition is substantially surrounded by such a package, most preferably totally surrounded by such a package. Any such package may contain one or more product formats as referred to herein.

### b) Non-Phosphorous Containing Builders

The non-phosphorous containing builder according to the present invention is an amino acid based compound or a succinate based compound. The term ‘succinate based compound’ and ‘succinic acid based compound’ are used interchangeably herein.

Preferred examples of amino acid based compounds according to the invention are MGDA (methyl-glycine-diacetic acid, and salts and derivatives thereof) and GLDA (glutamic-N,N-diacetic acid and salts and derivatives thereof). GLDA (salts and derivatives thereof) is especially preferred according to the invention, with the tetrasodium salt thereof being especially preferred. Other suitable builders are described in U.S. Pat. No. 6,426,229 which is incorporated by reference herein. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

Further preferred succinate compounds are described in U.S. Pat. No. 5,977,053 and have the formula

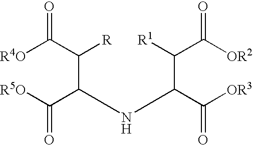

in which

R, R¹, independently of one another, denote H or OH, R², R³, R⁴, R⁵, independently of one another, denote a cation, hydrogen, alkali metal ions and ammonium ions, ammonium ions having the general formula R⁶R⁷R⁸R⁹N+ and R⁶, R⁷, R⁹, R⁹, independently of one another, denoting hydrogen, alkyl radicals having 1 to 12 C atoms or hydroxyl-substituted alkyl radicals having 2 to 3 C atoms. A preferred example is tetrasodium imminosuccinate.

Preferably the amino acid based compound or succinate based compound is present in the composition in an amount of at least 1 wt %, preferably at least 5 wt %, more preferably at least 10 wt %, and most preferably at least wt %. Preferably these compounds are present in an amount of up to 50 wt %, preferably up to 45 wt %, more preferably up to 40 wt %, and most preferably up to 35 wt %,

It is preferred that the composition aoptains 20% wt or less of phosphorous-containing ingredients, more preferably 10% wt or less, most preferably that they are substantially free of such ingredients and even more preferably they are free of such ingredients.

### c) Enzymes

The composition comprises one or more enzymes which are destabilised by the non-phosphorous containing builders of the invention. Without wishing to be bound by theory it is believed that the enzymes prone to destabilisation by these builders are those which comprise a metal ion which may be complexed by the builder.

It is preferred that the enzymes are selected from protease, lipase, amylase, cellulase and peroxidase enzymes. Such enzymes are commercially available and sold, for example, under the registered trade marks Esperase, Alcalase and Savinase by Nova Industries A/S and Maxatase by International Biosynthetics, Inc. It is most preferred that protease enzymes are included in the compositions according to the invention; such enzymes are effective for example in dishwashing detergent compostitions but yet are known to be particularly susceptible to being destabilised by the presence of the aforementioned types of builders.

Desirably the one or more enzyme(s) is/are present in the composition in an amount of from 0.01 to 3 wt %, especially 0.1 to 2.5 wt %, such as 0.2 to 2 wt %. It is especially preferred that the compositions comprise protease enzymes in the aforementioned amounts. A mixture of protease enzyme which is destabilised by the non-phosphorous builders and an amylase enzyme is preferred according to the invention.

### d) Stabilisation System for the Enzyme(s)

The stabilisation system according to the invention comprises one or more divalent metal compounds or salts and one or more non-ionic surfactants.

It is preferred that inorganic divalent metal salts are used. It is further preferred that the divalent metal compounds or salts comprise alkaline earth metal salts, especially calcium salts. Such salts are well known in the art and any suitable inorganic salts may be used. Chlorides and sulphates are especially preferred and phosphates are less preferred. Calcium chloride is an especially preferred calcium salt according to the invention.

The divalent metal compounds or salts are preferably present in the compositions of the invention in an amount of from 0.01 to 5% wt, more preferably 0.03% wt to 2% wt, such as 0.05% wt to 1% wt, e.g. 0.05% wt to 0.5% wt, such as 0.01 to 0.2% wt.

The stabilisation system further comprises one or more non-ionic surfactants. Preferably the non-ionic surfactants are chosen from alcohol ethoxylates, especially linear alcohol ethoxylates.

A preferred class of nonionic surfactants are ethoxylated non-ionic surfactants prepared by the reaction of a monohydroxy alkanol or alkylphenol with 6 to 20 carbon atoms. Preferably the surfactants have at least 12 moles, particularly preferred at least 16 moles, and still more preferred at least 20 moles of ethylene oxide per mole of alcohol or alkylphenol.

Particularly preferred non-ionic surfactants are the non-ionics from a linear chain fatty alcohol with 16-20 carbon atoms and at least 12 moles, particularly preferred at least 16, and still more preferred at least 20 moles, of ethylene oxide per mole of alcohol.

According to one embodiment of the invention, the non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant.

Surfactants which are ethoxylated mono-hydroxy alkanols or alkylphenols, which additionally comprises polyoxyethylene-polyoxypropylene block copolymer units may be used. The alcohol or alkylphenol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane.

Another preferred class of nonionic surfactant can be described by the formula:

R¹O[CH₂CH (CH₃)O]ₓ[CH₂CH₂O]_{y}[CH₂CH (OH) R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred nonionic surfactants are the end-capped polyoxyalkylated non-ionics of formula:

R¹O[CH₂CH (R³)O]ₓ[CH₂]ₖCH(OH)[CH₂]ⱼOR²

where R¹ and R² represent linear or branched chain, saturated or unsaturated, alyphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group , x is a value between 1 and 30 and, k and j are values between 1 and 12, preferably between 1 and 5. When the value of x is >2 each R³ in the formula above can be different. R¹ and R² are preferably linear or branched chain, saturated or unsaturated, alyphatic or aromatic hydrocarbon groups with 6-22 carbon atoms, where group with 8 to 18 carbon atoms are particularly preferred. For the group R³ H, methyl or ethyl are particularly preferred. Particularly preferred values for x are comprised between 1 and 20, preferably between 6 and 15.

As described above, in case x>2, each R³ in the formula 5, can be different. For instance, when x=3, the group R³ could be chosen to build ethylene oxide (R³═H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]ₓCH₂CH(OH)CH₂OR²

The use of mixtures of different nonionic surfactants is suitable in the context of the present invention for instances mixtures of alkoxylated alcohols and hydroxy group containing alkoxylated alcohols.

Other suitable surfactants are disclosed in WO 95/01416, to the contents of which express reference is hereby made.

Preferably the non-ionic surfactants are present in the compositions of the invention in an amount of from 0.1% wt to 5% wt, more preferably 0.5% wt to 3% wt, such as 0.5% wt to 2% wt or 2.5% wt.

### e) Eptional Ingredients

The detergent products of the invention may comprise other ingredients to those mentioned hereinabove.

The detergent compositions of the invention may further comprise a secondary builder (or cobuilder) in addition to the essential builders according to the invention. Preferred secondary builders include homopolymers and copolymers of polycarboxylic acids and their partially or completely neutralized salts, monomeric polycarboxylic acids and hydroxycarboxylic acids and their salts, phosphates and phosphonates, and mixtures of such substances provided that such substances do not fall into the definition of the non-phosphorous containing builder which is an amino acid based compound or a succinate-based compound builder according to the present invention. This statement is true for all secondary builders referred to herein. Preferred salts of the abovementioned compounds are the ammonium and/or alkali metal salts, i.e. the lithium, sodium, and potassium salts, and particularly preferred salts are the sodium salts.

Secondary builders which are organic are preferred.

Suitable polycarboxylic acids are acyclic, alicyclic, heterocyclic and aromatic carboxylic acids, in which case they contain at least two carboxyl groups which are in each case separated from one another by, preferably, no more than two carbon atoms.

Polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Polycarboxylates which contain three carboxyl groups include, for example, water-soluble citrate.

Correspondingly, a suitable hydroxycarboxylic acid is, for example, citric acid.

Another suitable polycarboxylic acid is the homopolymer of acrylic acid. Other suitable builders are disclosed in WO 95/01416, to the contents of which express reference is hereby made.

A bleaching compound may be present in a composition of the invention. However, as a bleach may adversely affect the stability of the enzymes further, it is preferred that the compositions comprise less than 10% wt of bleach compounds, more preferably less than 5% wt. It is most preferred that the compositions are substantially free of bleaching compounds and especially that they comprise no bleaching compounds.

It has been found, surprisingly, that the compositions of the present invention provide good cleaning effects against bleachable stains even when there is little or no bleaching compounds therein.

However, bleach may be present especially when it is present in a form whereby it cannot react with the enzymes present in the composition. For example when the bleach is encapsulated or otherwise physically separated from the enzymes. When a bleach is present, it is preferably present in the composition in an amount of at least 1 wt %, more preferably at least 2 wt %, more preferably at least 4 wt % and preferably present in the composition in an amount of up to 30 wt %, more preferably up to 20 wt %, and most preferably up to 15 wt %.

Most preferably a bleach is selected from inorganic perhydrates or organic peracids and the salts thereof.

Examples of inorganic perhydrates are persulfates such as peroxymonopersulfate (KMPS). Perborates or percarbonates are not excluded but are less favoured. The inorganic perhydrates are normally alkali metal salts, such as lithium, sodium or potassium salts, in particular sodium salts. A percarbonate may be present but is less preferred. When one is present the preferred percarbonate is sodium percarbonate of the formula 2Na₂CO₃.3H₂O₂.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

The dishwasher detergent according to the invention which contains a bleach compound May also comprise one or more bleach activators. Any conventional bleach activator may be used in conventional amounts.

The detergent composition according to the invention may also comprise one or more foam control agents. Suitable foam control agents for this purpose are all those used in this field, such as, for example, silicones and paraffin oil. The foam control agents are preferably present in the composition in amounts of 5% by weight or less of the total weight of the composition, for example, 2% by weight or less.

The detergent composition according to the invention may also comprise a source of acidity or a source of alkalinity, to obtain the desired pH, on dissolution. A source of acidity may suitably be any of the components mentioned above, which are acidic; for example polycarboxylic acids. A source of alkalinity may suitably be any suitable compound which is basic; for example any salt of a strong base and a weak acid. However additional acids or bases may be present. In the case of alkaline compositions silicates may be suitable additives. Preferred silicates are sodium silicates such as sodium disilicate, sodium metasilicate and crystalline phyllosilicates.

The dishwasher detergent according to the invention can also comprise a silver/copper corrosion inhibitor. This term encompasses agents which are intended to prevent or reduce the tarnishing of non-ferrous metals, in particular of silver and copper. Preferred silver/copper corrosion inhibitors are benzotriazole or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀-alkyl groups and hydroxyl, thio, phenyl or halogen such as fluorine, chlorine, bromine and iodine. A preferred substituted benzotriazole is tolyltriazole.

Organic and inorganic redox-active substances which are suitable as silver/copper corrosion inhibitors are also mentioned in WO 94/26860 and WO 94/26859, to the contents of which reference is hereby made. Suitable inorganic redox-active substances are, for example, metal salts and/or metal complexes chosen from the group consisting of zinc, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂ and Ce(NO₃)₃. Zinc salts, for example zinc sulphate or zinc acetate, e.g. zinc sulphate hexahydrate is an especially preferred corrosion inhibitor.

For example the composition may contain additional surface active agents to those non-ionic surfactants described under the stabilising system herein. For example anionic, cationic, amphoteric or zwitterionic surface active agents or mixtures thereof. Many such surfactants are described in Kirk Othmer's Encyclopedia of Chemical Technology, 3rd Ed., Vol. 22, pp. 360-379, “Surfactants and Detersive Systems”, incorporated by reference herein. In general, bleach-stable surfactants are preferred. Non-ionic surfactants which do not have a stabilising effect on the enzymes may also be included'in addition to those which do have a stabilising effect.

Other customary additives are, for example, dyes and perfumes and optionally in the case of liquid products, preservatives, suitable examples of which are compounds based on isothiazolinone. Thickeners may also be used in paste, liquid and gel products. Any suitable thickeners may be used with gums, polymers and gels being preferred.

Polymers intended to improve the cleaning performance of the detergent compositions may also be included therein. For example sulphonated polymers may be used. Preferred examples include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in Sulfonated (co)polymers are 2-acrylamido-2-methyl-1-propanesulfonic acid, 2-methacrylamido-2-methyl-1-propanesulfonic acid, 3-methacrylamido-2-hydroxy-propanesulfonic acid, allysulfonic acid, methallysulfonic acid, 2-hydroxy-3-(2-propenyloxy)propanesulfonic acid, 2-methyl-2-propenen-1-sulfonic acid, styrenesulfonic acid, vinylsulfonic acid, 3-sulfopropyl acrylate, 3-sulfopropylmethacrylate, sulfomethylacrylamide, sulfomethylmethacrylamide and water soluble salts thereof. Suitable sulfonated polymers are also described in U.S. Pat. No. 5,308,532 and in WO 2005/090541.

When a sulfonated polymer is present, it is preferably present in the composition in an amount of at least 0.1 wt %, preferably at least 0.5 wt %, more preferably at least 1 wt %, and most preferably at least 3 wt %, up to 40 wt %, preferably up to 25 wt %, more preferably up to 15 wt %, and most preferably up to 10 wt %.

The compositions of the invention may be made by any suitable method.

The composition is described with reference to the following non-limiting Examples. Further examples within the scope of the invention will be apparent to the person skilled in the art.

### Examples

The following liquid dishwashing formulation was prepared according to the formulation given in Table 1. All weights are given as the percentage by weight of active ingredient in the total product.

The xanthan gum was dispersed in the water and then remaining ingredients (except the enzymes) were added thereto and mixed until homogeneous. Finally the enzymes were added and the mixture mixed further.

TABLE 1

| | wt % |
|---|---|
| Zinc Sulfate Hexahydrate | 0.318 |
| GLDA (Dissolvine ™GL-74) | 31.006 |
| Citric acid | 5.473 |
| Xanthan Gum (Rhodopol ™23) | 0.400 |
| Nonionic surfactant | 1.485 |
| Protease enzyme (4000D blue) | 1.800 |
| Amylase enzyme (Termamyl ™ | 0.400 |
| Ultra 300L) | |
| Perfume | 0.300 |
| Dye | 0.005 |
| Calcium Chloride dihydrate | 0.077 |
| Water | 58.736 |
| Total | 100.000 |

Dissolvine is a tradename of Akzo Nobel,

The non-ionic surfactant in table 1 is Plurafac LF 4030 ex BASF, a linear alcohol ethoxylate.

The liquid formulation of example 1 had a pH at 1% wt of 9.3, at 10% wt of 8.8 and at 100% wt of 8.1. Its density was 1.26 g/cm³.

The above formulation was used to fill 28 water soluble pouches made of polyvinyl alcohol and the pouches were sealed, each pouch containing 19 g of liquid dishwashing formulation.

The detergent pouches were tested for stability upon storage as follows;

Protease

| | Storage Duration [Weeks] | | | | | |
|---|---|---|---|---|---|---|
| | Absolute Values | | | Recoveries [%] | | |
| Conditions | 0 | 1 | 12 | 0 | 1 | 12 |
| 25° C./50% r.h. | 1.00 | | 0.91 | 100.0 | | 91.0 |
| 30° C./70% r.h. | 1.00 | | 0.82 | 100.0 | | 81.0 |
| 40° C./75% r.h. | 1.00 | | 0.74 | 100.0 | | 74.0 |
| 50° C. | 1.00 | 0.91 | | 100.0 | 90.0 | |

Amylase

| | Storage Duration [Weeks] | | | | | |
|---|---|---|---|---|---|---|
| | Absolute Values | | | Recoveries [%] | | |
| Conditions | 0 | 1 | 12 | 0 | 1 | 12 |
| 25° C./50% r.h. | 0.54 | | 0.47 | 100.0 | | 87.0 |
| 30° C./70% r.h. | 0.54 | | 0.44 | 100.0 | | 82.0 |
| 40° C./75% r.h. | 0.54 | | 0.39 | 100.0 | | 73.0 |
| 50° C. | 0.54 | 0.37 | | 100.0 | 69.0 | |

The enzymes exhibited good stability upon storage despite the presence of the GLDA builder.

The compositions were also tested for cleaning efficacy as detailed below against a control formulation of a phosphate builder containing formulation. The cleaning performance was assessed in dishwasher trials;

Test product

| | phosphate based | |
|---|---|---|
| | detergent pouch | Example 1 GLDA |
| | (control) | containing pouch |
| Dosage | 1 pouch = 24.3 g | 1 pouch = 19.0 g |
| Repetitions | 4 | 4 |
| Bleacbable stains | 4.2 | 4.0 |
| TEA | 4.2 ± 0.14 | 4.0 — |
| Starch, dried-on | 9.0 | 9.2 |
| OAT FLAKES | 8.5 ± 0.35 | 8.6 ± 0.48 |
| STARCH MIX | 9.5 ± 0.55 | 9.9 ± 0.18 |
| Protein, dried-on | 7.4 | 7.7 |
| MINCED MEAT | 9.8 ± 0.35 | 9.5 ± 0.20 |
| EGG YOLK | 5.6 ± 0.17 | 6.1 ± 0.30 |
| EGG YOLK/MILK | 7.0 ± 0.24 | 7.5 ± 0.30 |
| Burnt-on Stains | 7.6 | 7.5 |
| MILK | 7.6 ± 0.17 | 7.5 ± 0.37 |
| Average | 7.0 | 7.1 |

Water hardness: 9° dH (49° C.)

Scores: 10=complete removal of soil.

The detergent compositions according to the present invention exhibit very good cleaning performance comparable to that obtained for a phosphate based dishwashing product, even though it contained less dishwashing product.

1. A detergent composition comprising;
a) a non-phosphorous containing builder which is an amino acid based compound or a succinate based compound,
b) one or more enzymes which are destabilised by the non-phosphorous containing builder, and
c) a stabilisation system for the one or more enzymes wherein the stabilisation system comprises one or more divalent metal compounds or salts and one or more non-ionic surfactants.

2. A detergent composition according to claim 1, wherein the composition is a dishwashing detergent product.

3. A detergent composition according to claim 1, wherein the detergent composition is substantially free of phosphorous-containing ingredients.

4. A detergent composition according to claim 1, wherein the composition is in the form of a paste, gel or liquid.

5. A detergent composition according to claim 1, wherein the composition is in the form of a unit dose product.

6. A detergent composition according to claim 1 which is a paste, gel or liquid composition at least partially surrounded by a water-soluble package.

7. A detergent composition according to claim 1, wherein the amino acid based compound or a succinate based compound is the tetrasodium salt of glutamic-N,N-diacetic acid or methyl-glycine-diacetic acid.

8. A detergent composition according to claim 1, wherein the builder is present in the composition in an amount of from 10 wt % to 40 wt %.

9. A detergent composition according to claim 1, wherein the one or more enzymes comprise a protease enzyme.

10. A detergent composition according to claim 9, wherein the composition comprises 0.01 to 3 wt % protease enzyme(s).

11. A detergent composition according to claim 1, wherein the divalent metal compounds or salts comprise alkaline earth metal salts.

12. A detergent composition according to claim 11, wherein the alkaline earth metal salts comprise calcium salts.

13. A detergent composition according to claim 12, wherein the calcium salt comprises calcium chloride.

14. A detergent composition according to claim 11, wherein the divalent metal compounds or salts are present in an amount of 0.01 to 5% wt.

15. A detergent composition according to claim 1, wherein the non-ionic surfactants are chosen from alcohol ethoxylates.

16. A detergent composition according to claim 1, wherein the non-ionic surfactants are present in an amount of 0.1 to 5% wt.
